(19) United States
(12) Patent Application Publication
(10) Pub. No.: US 2024/0362187 A1
(43) Pub. Date: Oct. 31, 2024

(54) METHOD AND SYSTEM FOR OVERWRITING-BASED DELETION OF INFORMATION AND VERIFICATION OF DELETION

(71) Applicant: Huazhong University of Science and Technology, Wuhan (CN)

(72) Inventors: Peng XU, Wuhan (CN); Shuning XU, Wuhan (CN); Wei WANG, Wuhan (CN); Runze XU, Wuhan (CN); Tingting RAO, Wuhan (CN); Hai JIN, Wuhan (CN)

(21) Appl. No.: 18/631,660

(22) Filed: Apr. 10, 2024

(30) Foreign Application Priority Data
Apr. 27, 2023 (CN) 202310472519.9

(51) Int. Cl. G06F 16/16; G06F 21/60

(52) U.S. Cl. CPC G06F 16/162; G06F 21/60; G06F 2221/2143

(57) ABSTRACT

A method and system for overwriting-based deletion of information and verification of deletion is provided, wherein the method at least includes: receiving a deletion request and/or a random seed; performing fine-grained overwriting on the information by means of random overwriting; in response to an extraction request for a post-deletion state, making a master node in a source domain of the information broadcast the extraction request to at least one slave node; and sending the post-deletion state fed back by the slave node and a related state-verification parameter to a verifying terminal, so that the verifying terminal verifies an overwriting result based on a verifiable pseudo-random function. Thus, the present application can effectively prevent information recovery after being logically deleted, and efficaciously ensure verifiability as well as non-recoverability of deleted information, thereby assuring non-recoverable deletion and providing verifiability of deletion to information subjects.

This application claims priority to Chinese Patent Application No. CN 202310472519.9 filed on Apr. 27, 2023, which is hereby incorporated by reference as if fully set forth herein.

### BACKGROUND OF THE APPLICATION

### Field

The present disclosure generally relates to information technology, and particularly to a method and a system for deleting information and verifying deletion. The present disclosure is more particularly relates to a method and a system for overwriting-based deletion of information and verification of deletion.

### Description of Related Art

In the era of big data, various kinds of information are extensively collected and used. As reported in some studies, enterprises doing Internet-related business usually undertake to delete information they collect from customers, or information subjects as used hereinafter, for providing services, after the services have been completed and the data are no more needed. However, it is a common situation that ownership and management of such information are separated, making it difficult for information subjects to confirm whether the information is duly deleted. Since enterprises seldom provide information subjects with any technical verification about deletion of information, information subjects cannot but believe that these enterprises do fulfill their promises. After accomplishing deletion of information, an enterprise may simply inform a relevant information subject whether deletion succeeds or failed, and the information subject has no way to verify this result. As a matter of fact, most of these collected personal information of information subjects still exists in some physical hard drives or other similar devices, and is in the risk of breach. Or, enterprises may furtively keep the information for their own interests or even illegally share the information with a third party for commercial use, and infringe benefits of the aggrieved information subject seriously.

As a known solution to the problems about poor deletion performance and inability to verify deletion results, upon input of new personal information, overwriting is performed on information to be deleted, and verification is conducted to ensure assured and irrevocable deletion of the information. Currently, studies about deletion of information have identified two major challenges to be overcome. The first is, for information provided to enterprises by information subjects, the relevant information subjects and enterprises need to be assured that information has been deleted. The second issue is verification of assured deletion of information that has been circulated across multiple domains. Currently, for effectively ensuring deletion of information, the information is subject to overwriting. Such overwriting is mainly achieved in the forms of all-zero data overwriting, random data overwriting, and mixed data overwriting. After being deleted through overwriting, the original information is hard to recover without specially designed recovering tools and means. This method can effectively ensure the deterministic deletion of information. As to verification of deletion, the known approaches include those using secret keys, those based on overwriting, those based on assured execution environments, and those based on blockchains. However, existing research has the problem of key leakage. Besides, as new information and deleted information increasingly grow, the amount of verifiable proof of deletion redoubles, which means heavier computing loads to cloud servers, higher overheads for communication and storage, as well as slower verification.

For example, China Patent Publication No. CN112115101B has disclosed a method and a system for deterministically deleting data in cloud storage, wherein the method comprises the following steps: 1) the cloud checks the validity of a deterministic deletion instruction sent by a user; if the instruction is legal, deleting the corresponding link, forwarding the instruction to the blockchain network, and performing the step 2); otherwise, refusing to execute the instruction; 2) the blockchain network triggers a corresponding intelligent contract according to the instruction, generates an overwriting seed and sends the overwriting seed to the cloud; 3) the cloud overwrites the data block appointed in the instruction based on the overwriting seed according to the intelligent contract and the agreed overwriting rule; 4) a verifiable block is selected by the blockchain network to initiate a challenge of deleting verification on the cloud; 5) the cloud generates a homomorphic verifiable label for the challenged verifiable block, and returns the homomorphic verifiable label to the blockchain network as the overwriting evidence; and 6) the blockchain network verifies the cloud's returned evidence according to the overwriting basic value and the overwriting rule generated by the overwriting seed, and records the verification process and the result in the blockchain network. The existing solution involves use of a blockchain network, and thus has disadvantages about high communication overheads and computing costs. Besides, in the known solution, storage and deletion of cloud data are only performed at a fixed level of granularity, and it lacks for an effective approach to verification of correlation deletion of information having multiple copies. Therefore, there is an urgent need to study efficient information multi-copy and verifiable deletion schemes.

Since there is certainly discrepancy between the existing art comprehended by the applicant of this patent application and that known by the patent examiners and since there are many details and disclosures disclosed in literatures and patent documents that have been referred by the applicant during creation of the present disclosure not exhaustively recited here, it is to be noted that the present disclosure shall actually include technical features of all of these existing works, and the applicant reserves the right to supplement the application with the related art more existing technical features as support according to relevant regulations.

### SUMMARY

In view of the shortcomings of the existing art, the present disclosure provides a method for overwriting-based deletion of information and verification of deletion, the method at least comprises:
receiving a deletion request and/or a random seed;
performing fine-grained overwriting on the information by means of random overwriting;
in response to an extraction request for extracting a post-deletion state, making a master node in a source domain of the information broadcast the extraction request to at least one slave node;
sending the post-deletion state fed back by the slave node and a related state-verification parameter to a verifying terminal, so that the verifying terminal verifies an overwriting result based on a verifiable pseudo-random function.

According to the requirements of information deletion, a proper overwriting means is selected from many random overwriting policies to perform random overwriting on the information, thereby achieving fine-grained physical deletion of the information through overwrite. The present invention has a better deletion effect than the traditional logical deletion method in terms of deterministic deletion of information, and effectively solves the problem of recoverable logical deletion of information; moreover, the present disclosure realizes remote verification of deletion based on pseudo-random overwriting, so as to enable deletion with verifiability as desired by information subjects.

Preferably, the step of performing fine-grained overwriting on the information by means of random overwriting at least comprises: determining at least one random overwriting policy based on a deletion requirement of the verifying terminal.

For multi-copy information, the present disclosure further performs verification on post-deletion state stored in different slave nodes, and provides multiple random overwriting policies for random overwriting of information to meet requirements of information subjects, thereby achieving fine-grained physical deletion of information through overwriting. Additionally, the present disclosure uses the verifiable pseudo-random function based on an elliptic curve to realize remote verification of deletion that implements pseudo-random overwriting, so it helps achieve good efficiency and security, thereby providing verifiable deletion of information as desired by information subjects.

Preferably, the random overwriting policy is selected at least from: a single-time overwriting policy, which is about making rule-based changes to the random seed corresponding to a counter mode, and overwriting a target storage area in the slave node in a chunkwise manner, wherein the target storage area stores information to be deleted; and a repetitive overwriting policy, which is about overwriting the target storage area by alternately using at least two different overwriting means, and the third overwriting method is used to perform the last overwriting operation of the target storage area.

Preferably, the overwriting means at least include one of: using the random number to overwrite the target storage area; use the random number bitwise negation result to cover the target information storage area; and making the rule-based changes to the random seed corresponding to the counter mode, and overwriting chunks of the target storage area, respectively.

Preferably, the verification parameter related to the post-deletion state is calculated at least through:
calculating a proof parameter based on a private key possessed by the master node,

proof=VRF_MakeProof(SK,seed),
where proof represents the proof parameter, and VRF_MakeProof represents the proof-making algorithm of the verifiable pseudo-random function.

Preferably, the verifying terminal verifies an overwriting result based on a verifiable pseudo-random function through: based on the proof-making algorithm of the verifiable pseudo-random function, calculating the proof parameter so as to obtain result information; determining whether the post-deletion state and the result information are equal; and if the two are equal, proceeding with verification.

Preferably, the verifying terminal verifies the overwriting result based on the verifiable pseudo-random function further through: performing verification based on a public key possessed by the verifying terminal, the random seed, and the proof parameter, and if a result of the verification is False, determining that verification fails and random overwriting of deletion target fails; or if the result of the verification is True, determining that verification succeeds.

The present disclosure further provides a server for overwriting-based deletion of information and verification of deletion, wherein the server is for: receiving a deletion request and random seed; performing fine-grained overwriting on the information by means of random overwriting; in response to an extraction request for extracting the post-deletion state, making a master node in a source domain of the information broadcast the extraction request to at least one slave node; and sending the post-deletion state fed back by the slave node and a related state-verification parameter to a verifying terminal, so that the verifying terminal verifies an overwriting result based on a verifiable pseudo-random function.

The present disclosure further provides a system for overwriting-based deletion of information and verification of deletion, wherein the system comprises at least one verifying terminal and a server, wherein
the verifying terminal is for: sending a deletion request and/or random seed to the server; and receiving a post-deletion state and its related verification parameter sent by the server and verifying overwriting result based on a verifiable pseudo-random function; and
the server is for: receiving a deletion request and/or a random seed; performing fine-grained overwriting on the information by means of random overwriting; in response to an extraction request for extracting a post-deletion state, making a master node in a source domain of the information broadcast the extraction request to at least one slave node; and sending the post-deletion state fed back by the slave node and a related state-verification parameter to a verifying terminal, so that the verifying terminal verifies an overwriting result based on a verifiable pseudo-random function.

Preferably, the server performs fine-grained overwriting on the information by means of random overwriting at least through:
determining at least one random overwriting policy based on a deletion requirement of the verifying terminal;
wherein the random overwriting policy at least includes:
a single-time overwriting policy, which is about making rule-based changes to the random seed corresponding to a counter mode, and overwriting a target storage area in the slave node in a chunkwise manner, wherein the target storage area stores information to be deleted; and
a repetitive overwriting policy, which is about overwriting the target storage area by alternately using at least two different overwriting means, and the third overwriting method is used to perform the last overwriting operation of the target storage area.

### BRIEF DESCRIPTION OF THE DRAWINGS

FIG. 1 is a simplified modular diagram of a system for deleting information and verifying deletion according to a preferred mode of the present disclosure.

### DETAILED DESCRIPTION

The present disclosure will be further detailed below with reference to accompanying drawings and particular embodiments.

The present disclosure provides a method and a system for deleting information and verifying deletion. The present disclosure further provides an information security system. The present disclosure also provides a system and a method for monitoring information security. The present disclosure additionally provides a terminal for verifying deletion of information.

Some technical terms used in the disclosure are defined as below.

Elliptic-curve-based verifiable random functions (VRFs) are verifiable random function algorithms based on elliptic curves. Verifiable random functions (VRFs) are essentially a type of pseudo-random functions enabling verification. In response to input of particular random seed (seed) and the private key (SK) of the inputter, the verifiable random function (VRF) outputs a random number (result) and a proof (proof). The verifying terminal uses the output random number, the proof, and the input random seed to verify whether the random number is generated from the corresponding input.

The verifiable random function algorithm is primarily composed of the following four algorithms:
(1) SetUp(1^{λ})→(params): this is a system-initializing algorithm. Its input is a system security parameter λ, and it outputs a public parameter params.
(2) GenKey(params)→(PK, SK): this is a secret-key-generating algorithm. Its input is the public parameter params, and it outputs a public key PK and a private key SK.
(3) MakeProof(SK,seed)→(result, proof): this is a random-number- and proof-making algorithm. Its input is a random seed seed and the private key SK, and it outputs a random number result and its proof proof.
(4) Verify(PK,seed,proof)→(True/False): this is a verification algorithm. Its input is the random seed seed, the proof proof, and the public key PK, and it outputs a verification result True/False.

The verifiable random function algorithm is executed as below:

### (1) System Initializing Algorithm SetUp

System parameters initialized include: GF(q) representing a q^{th}-order finite domain, q representing a λ-digit large prime, E representing an elliptic curve defined in GF(q), and G representing the base point of the elliptic curve.

### (2) Secret Key Generating Algorithm GenKey

At a step 11, a random number x∈[1, q−1] is selected.

At a step 12, a pair of elliptic-curve secret keys is generated, wherein the private key SK is x, and the public key PK is Y=xG.

### (3) Random Number- and Proof-Making Algorithm MakeProof

Herein, the input includes a random seed seed and the private key SK, namely x.

Its output includes a random number result and a proof proof.

At S21, a random number k∈[1, q−1] is selected.

S22 is about using the Hash function H₁ to calculate H=H₁(seed), and mapping the random seed seed to a point H in an elliptic curve.

S23 involves calculation of kH, kG.

S24 is about using the Hash function H₃ to encode the input into an integer c=H₃(kG,kH).

At S25, calculation of s=(k−c*x) mod q is performed to take a remainder, where q represents a λ-digit large prime.

S26 is about using the private key x to calculate Γ=xH.

S27 is about using the Hash function H₂ to encode the point in the elliptic curve into an integer, so as to obtain a random number result=H₂(Γ), with the proof as (Γ, c, s).

Therein, the functions H₁, H₂, H₃ are typically Hash algorithms that satisfy the nature of Hash functions. Common Hash algorithms include MD5, SHA-1, SHA-2, and a message digest algorithm SM3 developed in China. The Hash function H₁ serves to map an arbitrary message to an elliptic curve. The Hash function H₂ serves to map a point in an elliptic curve into an integer. Exemplarily, the point may be first serialized into a byte stream, and then calculation is performed to get the hash value of the byte stream. The H₃ function serves to map an input of an arbitrary length into an l-digit integer. The parameters accepted by H₃ are one or more points in an elliptic curve. Exemplarily, a method of NIST SP800-90A may be implemented to map an integer of an arbitrary length into an integer c. This ensures that a given input always yields the same output.

### (4) Verification Algorithm Verify

The input includes a random seed seed′ and a proof proof′.

It outputs the correctness (True/False).

S31 is about using the Hash function H₁ to map the random seed seed′ onto a point H′ in the elliptic curve.

At S32, the proof proof′(Γ′, c′, s′) is used in calculation of U=c′Y+s′G; V=c′Γ+s′H, where c′ is the c′ from the proof proof′(Γ′, c′, s′), representing an integer, and s′ is the s′ from the proof proof′(Γ′, c′, s′), representing a random seed.

At S33, calculation of c′=H₃(U,V) is performed. If proof has not been tampered and seed′=seed, then Γ′=Γ, c′=c, s′=s. From s=(k−c*x) mod q→s+c*x=k, it is derived that

$$U = {c}^{′} Y + {s}^{′} G = {c}^{′} * xG + {s}^{′} G = k G , V = {c}^{′} Γ + {s}^{′} H = {c}^{′} * xH + {s}^{′} H = k H ,$$

then it can be derived c′=H₃(kG, kH).

At S34, if c=c′, it indicates that the random number is valid, and the verification succeeds, making True output. Otherwise, it means that the random number is invalid and the verification fails, making False output.

In the present disclosure, information may have multiple copies in some domain D. There are many storage nodes in the domain D forming a master-slave system. These nodes may be an in-domain master node N and in-domain slave nodes N₁, . . . , Nₙ, and in every slave node there are many storage copies.

A front end refers to the end interacting with a verifying terminal, and a front end of a server comprises in-domain master nodes.

A back end refers to a storage node that interacts with a front end, and a back end of a server comprises in-domain slave nodes.

A master node refers to a controlling node, and may be a device that initiates a request for extracting the post-deletion state to slave nodes.

A slave node refers to a storage node, and may be a device that stores nodes related to the post-deletion state.

A random seed refers to a random number seed.

A random number F_{R} is a random number different from seed.

A random bit stream is a string of random binary data.

The post-deletion state refers to information about the current state of the server after the information is deleted.

In view of the problems about deletion of information, in particular inferior performance and non-verification, the present disclosure provides methods for deletion of information based on random overwriting and for remotely verifying overwriting-based deletion using verifiable pseudo-random functions, which effectively prevent information recoverability after being logically deleted, and efficaciously ensure verifiability as well as non-recoverability of deleted information, assuring non-recoverable deletion and providing verifiability of deletion to information subjects. In the present disclosure, the described information is illustrative. The information to be deleted is not limited to any certain type of data, and may be any types of designated data.

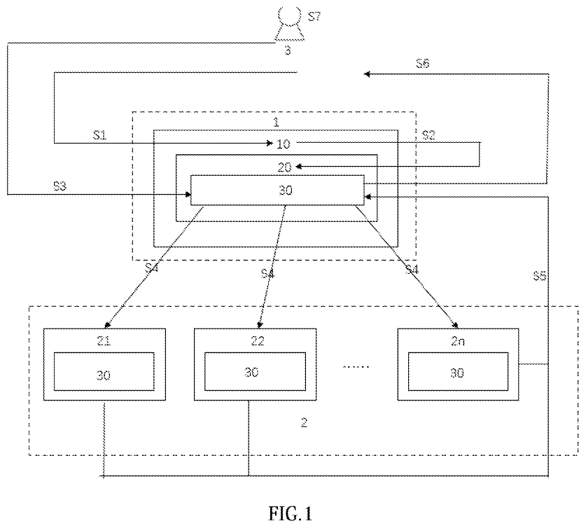

As shown in FIG. 1, in the present disclosure, the system for overwriting-based deletion of information and verification of deletion comprises at least one verifying terminal 3 and at least one server. The verifying terminal 3 and the server are in wired and/or wireless connection with each other.

The server comprises a front end 1 and a back end 2. The front end 1 has plural in-domain master nodes 10 built therein. The back end 2 has some in-domain slave nodes. The in-domain slave nodes may include, for example, a first slave node 21, a second slave node 22 . . . and an N^{th} slave node 2n.

The verifying terminal 3 possesses a public key PK used in overwriting-based deletion of information and remote verification of deletion. It serves to issue a deletion request and verify the related parameters fed back by the server, so as to verify whether the information of interest has been deleted. The verifying terminal 3 may be a human-machine interaction-enabled device, such as a computer, a smart portable device, a tablet, etc. Such a smart portable device may be, for example, a smartphone, a smart watch, smart glasses, a VR device, etc. The verifying terminal 3 is further used to select a proper overwriting policy.

In the present disclosure, the verifying terminal 3 during the deletion overwriting process selects a proper overwriting means, and sends the specific deletion request and the random seed seed to the server. In the process of remote verification, the verifying terminal receives the post-deletion state and the related verification parameter proof from the server, and then executes the verification algorithm for VRF to verify whether the deletion target has been randomly overwritten successfully, then complete the remote verification and get the deletion effect.

The server in the present disclosure possesses a private key SK used in overwriting-based deletion of information and remote verification of deletion. It serves to delete information using a designated overwriting policy, and send the post-deletion state W and the related verification parameters to the verifying terminal for the verifying terminal to verify overwriting result using verifiable pseudo-random functions.

The server operates on the principle as described below. According to the deletion requirement sent by the verifying terminal, the server executes the proof-making algorithm of VRF during overwriting-based deletion and obtains verifiable overwriting result result. To be specific, a random bit stream is used in overwriting to replace and thereby delete the target storage area DataOW(CT)→(result). During remote verification, the in-domain master node in the information source domain Do extracts the post-deletion state W that is generated after the storage area of the information is overwritten as result from each of the in-domain slave nodes in the domains {D₁, D₂, . . . , Dₙ}. Then the post-deletion state W and the related verification parameters are sent to the verifying terminal for the verifying terminal to verify overwriting result using verifiable pseudo-random functions.

During deletion of information, the verifying terminal operates as described below.

At S1, the verifying terminal send a deletion request to the server, and sends a random seed seed at the same time.

The deletion request contains specific deletion requirement from the information subject. The specific deletion requirement is a proper overwriting means selected by the information subject from at least one random overwriting policy. The overwriting means is sent to the server by the verifying terminal as a deletion request.

In a case where a random overwriting means is to be performed for multiple times, such as three or seven times, the deletion request sent by the verifying terminal contains a random number F_{R} in addition to the specific deletion requirement from the information subject. The random seed seed is selected by the verifying terminal and sent to the server as an input for the proof-making algorithm for VRF to overwrite the target storage area.

During deletion of information, the server operates as below.

At S2, it receives a deletion request from the verifying terminal, and uses the designated random overwriting means to accomplish fine-grained deletion of personal information based on overwriting.

In the case where the deletion request does not provide a random number F_{R}, the in-domain master node implements the single-time overwriting policy. In other words, it uses a random number to overwrite a target storage area in the slave node that stores the information of interest by overwriting the target storage area to be deleted chunkwise. Then the received random seed seed is directly used as an input for the proof-making algorithm of VRF, thereby accomplishing the last overwriting step.

Preferably, the in-domain master node overwrites the target storage area CT chunkwise. The in-domain master node uses the counter mode to divide the target storage area CT into CT₁, . . . , CTᵢ. For the chunk CT₁, the random seed seed is used to calculate result₁=VRF_MakeProof(SK,seed). For every subsequent chunk, an increment of 1 is applied to the random seed successively, so for the chunk CTᵢ, the used random seed seed′=seed+i−1. Then calculation is performed for resultᵢ=VRF_MakeProof(SK,seed′), so as to eventually obtain a verifiable overwriting content result. By using a random bit stream in overwriting, deletion of the target storage area DataOW(CT)→(result) is achieved, so as to provide primary deletion.

Where the deletion request contains a random number F_{R}, the in-domain master node executes the repetitive overwriting policy. To be specific, at least two different overwriting means are alternately used to overwrite to the target storage area, and a third overwriting means is used to overwrite the target storage area for a final time. Preferably, the repetitive overwriting policy includes at least three-time overwriting and seven-time overwriting.

For three-time overwriting, the random number F_{R} is used for the first time of overwriting to overwrite the target storage area, and the random number bitwise negation result F_{R}′ is used for the second time. As to the third time, a new random number seed is used. The deletion target storage area CT is divided into chunks CT₁, . . . , CTᵢ, CT₁ using the counter mode. And the new random seed seed is used to calculate result₁=VRF_MakeProof(SK,seed). For every subsequent chunk, an increment of 1 is applied to the random seed successively, so for the chunk CTᵢ, the used random seed seed′=seed+i−1. Then calculation is performed for result: =VRF_MakeProof(SK,seed′), so as to eventually obtain a verifiable overwriting content result. By using a random bit stream in overwriting, deletion of the target storage area is achieved, so as to provide medium deletion.

For seven-time overwriting, the random number F_{R} is used for the first time of overwriting to overwrite the target storage area, and the random number bitwise negation result F_{R}′ is used for the second time. Then the same alternation is repeated for two more times. As to the last time, a new random number seed is used. The deletion target storage area CT is divided into chunks CT₁, . . . , CTᵢ, CT₁ using the counter mode. And the new random seed seed is used to calculate result₁=VRF_MakeProof(SK,seed). For every subsequent chunk, an increment of 1 is applied to the random seed successively, so for the chunk CTᵢ, the used random seed seed′=seed+i−1. Then calculation is performed for result=VRF_MakeProof(SK,seed′), so as to eventually obtain a verifiable overwriting content result. By using a random bit stream in overwriting, deletion of the target storage area is achieved, so as to provide strong deletion.

The present disclosure uses three different random overwriting policies to realize different levels of deletion, and implements single-time, three-time, and seven-time overwriting to provide weak, medium, and strong deletion. The present disclosure further adopts the random overwriting policy to achieve fine-grained overwriting-based deletion of information. From the three different random overwriting policies, a proper overwriting means is selected according to the deletion requirement for designated information, so as to obtain verifiable overwriting result to overwrite the target storage area to be deleted.

By strategically using three different random overwriting policies, different levels of deletion can be achieved, such as weak deletion, medium deletion, and strong deletion. Overwriting may be conducted for three or seven times. Three-time overwriting is about conducting the first two times of overwriting differently, and then using a further overwriting means to perform the last time of overwriting. This scheme is advantageous for it to ensure full-coverage overwriting with minimal possible times of overwriting using different overwriting means. Seven-time overwriting is about using a random number and the random number bitwise negation result to perform overwriting and then repeating the same method for achieving coverage as complete as possible. In order to ensure full coverage, the two different overwrite means are implemented again, after which a third overwriting means is used, so as to provide strong deletion.

Alternatively, strong deletion may be achieved using more than seven times of overwriting, such as nine, eleven, or any larger odd number times of overwriting. However, the deletion effect of odd overwrites such as nine overwrites and eleven overwrites is similar to the deletion effect of seven overwrites. Therefore, seven-time overwriting is more preferable.

Preferably, when the verifying terminal and the server conduct remote verification, their interaction is as below.

At S3, the verifying terminal initiates a request p for extracting post-deletion state W to in-domain master nodes in the information source domain D₀ of the server.

At S4, the in-domain master node in the information source domain D₀ of the server receives the extraction request p from the verifying terminal, and sends a request for extracting post-deletion state W to in-domain slave nodes in all the domains {D₁, D₂, . . . , Dₙ}.

At S5, the in-domain master node receives the post-deletion state W sent by each of the in-domain slave nodes in the domains {D₁, D₂, . . . , Dₙ} of the information storage area after being overwritten as result.

At S6, the server sends the post-deletion state W and the related verification parameters to the verifying terminal, so that the verifying terminal can verify the overwriting result based on verifiable pseudo-random function.

The related verification parameters include a proof parameter proof. The proof parameter proof is obtained by the in-domain master node through executing the proof-making algorithm of VRF using the random seed seed as the input. In the equation of the proof parameter proof=VRF_MakeProof(SK,seed), SK represents the private key.

After the post-deletion state as the result of overwriting the information storage area is generated, the in-domain master node in the information source domain extracts the post-deletion state from each of the in-domain slave nodes of the domains for subsequent verification of overwriting result based on the verifiable pseudo-random functions VRF.

At S7, the verifying terminal receives the post-deletion state and the related verification parameters proof from the server, and calculates the result information W₁=VRF_MakeProof(proof).

The verifying terminal determines whether the post-deletion state W and the result information W₁ are equal. If they are equal, the method is proceeded with the following steps. The extracted post-deletion state of personal information is a data stream, the result information is also a data stream. Thus, comparison between the two is possible for determination.

The verifying terminal executes the Verify algorithm as the input for executing VRF to calculate True/False=VRF_Verify(PK,seed,proof) and thereby obtains a verification result. If the result is False, it means that verification fails and the random overwriting is not performed successfully on the deletion target. If the result is True, this means that verification succeeds. With a pseudo-random number as the overwriting result, the deletion target has been successfully overwritten in a random manner, then complete the remote verification and get the deletion effect.
(1) Multi-time overwriting is more advantageous than single-time overwriting for it to enable maximum possible coverage of overwriting, thereby ensuring good performance of overwriting-based deletion;
(2) During multi-time overwriting, two overwriting means are implemented alternately and this helps achieve full coverage and eliminate any omission, thereby ensuring full-coverage deletion; and
(3) The last time of overwriting is performed in a chunkwise manner to advantageously ensure that data in different chunks are overwritten using different random numbers, thereby achieving full coverage and ideal deletion result.

### Embodiment 1

The present disclosure provides a method for overwriting-based deletion of information and verification of deletion, which is to be implemented by a server. The method at least comprises:
receiving a deletion request and/or a random seed;
performing fine-grained overwriting on the information by means of random overwriting;
in response to an extraction request for extracting a post-deletion state, making a master node in a source domain of the information broadcast the extraction request to at least one slave node; and
sending the post-deletion state fed back by the slave node and a related state-verification parameter to a verifying terminal, so that the verifying terminal verifies an overwriting result based on a verifiable pseudo-random function.

Preferably, the step of performing fine-grained overwriting on the information by means of random overwriting at least comprises: determining at least one random overwriting policy based on a deletion requirement of the verifying terminal.

Preferably, the random overwriting policy is selected at least from:
a single-time overwriting policy, which is about making rule-based changes to the random seed corresponding to a counter mode, and overwriting a target storage area in the slave node in a chunkwise manner, wherein the target storage area stores information to be deleted; and
a repetitive overwriting policy, which is about overwriting the target storage area by alternately using at least two different overwriting means, and the third overwriting method is used to perform the last overwriting operation of the target storage area.

Preferably, the overwriting means at least include one of:
using the random number to overwrite the target storage area, i.e., the first overwriting means.

Using the random number bitwise negation result to overwrite the target storage area, i.e., the second overwriting means.
making the rule-based changes to the random seed corresponding to the counter mode, and overwriting chunks of the target storage area, respectively, i.e., the third overwriting means.

Preferably, the verifying terminal verifies the overwriting result based on the verifiable pseudo-random function further at least through: performing verification based on a public key possessed by the verifying terminal, the random seed, and the proof parameter, and
if a result of the verification is False, determining that verification fails and deletion of the target storage area through overwriting based on the random seed fails; or
if the result of the verification is True, determining that verification succeeds.

### Embodiment 2

The present embodiment provides further improvements on Embodiment 1, and repeated details are omitted from the description thereof.

The present embodiment provides a verifying terminal. The verifying terminal is configured to execute the following steps.

At S21, it sends a deletion request to the server, and sends a random seed seed at the same time.

The deletion request contains a specific deletion requirement from the information subject. The specific deletion requirement is herein the overwriting means selected by the information subject from at least one random overwriting policy.

The deletion requirement and the selected overwriting means are input through the verifying terminal. The selected overwriting means is contained in the deletion request sent to the server by the verifying terminal.

In an example where a random overwriting means is used to conduct multiple times of overwriting, such as three or seven times, the deletion request issued by the verifying terminal further contains a random number F_{R} in addition to the specific deletion requirement from the information subject. The random seed seed is selected by the verifying terminal and sent to the server for the server to execute the proof-making algorithm VRF, thereby overwriting the target storage area.

At S22, the verifying terminal raises an extraction request p about the post-deletion state W to the in-domain master node 10 of the information source domain D₀ of the server.

At S23, after receiving the post-deletion state W and the related verification parameter proof sent by the server, the verifying terminal calculates the post-deletion state W=VRF_MakeProof(proof).

The verifying terminal determines whether the post-deletion state W is equal to the result information obtained from the proof parameter proof based on the proof-making algorithm of the verifiable pseudo-random function. If they are equal, the following steps are conducted.

The verifying terminal executes the proof-making algorithm as the input for executing VRF to calculate True/False=VRF_Verify(PK,seed,proof) and thereby obtains a verification result. If the result is False, it means that verification fails and the random overwriting is not performed successfully on the deletion target. If the result is True, this means that verification succeeds. With a pseudo-random number as the overwriting result, the deletion target has been successfully overwritten in a random manner, then complete the remote verification and get the deletion effect.

It is to be noted that the particular embodiments described previously are exemplary. People skilled in the art, with inspiration from the disclosure of the present disclosure, would be able to devise various solutions, and all these solutions shall be regarded as a part of the disclosure and protected by the present disclosure. Further, people skilled in the art would appreciate that the descriptions and accompanying drawings provided herein are illustrative and form no limitation to any of the appended claims. The scope of the present disclosure is defined by the appended claims and equivalents thereof. The disclosure provided herein contains various inventive concepts, such of those described in sections led by terms or phrases like “preferably”, “according to one preferred mode” or “optionally”. Each of the inventive concepts represents an independent conception and the applicant reserves the right to file one or more divisional applications therefor.

What is claimed is:

1. A method for overwriting-based deletion of information and verification of deletion, the method at least comprising:
receiving a deletion request and/or a random seed;
performing fine-grained overwriting on the information by means of random overwriting;
in response to an extraction request for extracting a post-deletion state, making a master node in a source domain of the information broadcast the extraction request to at least one slave node; and
sending the post-deletion state fed back by the slave node and a related state-verification parameter to a verifying terminal, so that the verifying terminal verifies an overwriting result based on a verifiable pseudo-random function.

2. The method of claim 1, wherein the step of performing fine-grained overwriting on the information by means of random overwriting at least comprises:
determining at least one random overwriting policy based on a deletion requirement of the verifying terminal.

3. The method of claim 2, wherein the random overwriting policy is selected at least from:
a single-time overwriting policy, which is about making rule-based changes to the random seed corresponding to a counter mode, and overwriting a target storage area in the slave node in a chunkwise manner, wherein the target storage area stores information to be deleted; and
a repetitive overwriting policy, which is about overwriting the target storage area by alternately using at least two different overwriting means, and the third overwriting method is used to perform the last overwriting operation of the target storage area.

4. The method of claim 3, wherein the overwriting means at least include one of:
using the random number to overwrite the target storage area;
using the random number bitwise negation result to overwrite the target storage area; and
making the rule-based changes to the random seed corresponding to the counter mode, and overwriting chunks of the target storage area, respectively.

5. The method of claim 4, wherein the verification parameter related to the post-deletion state is calculated at least through:
calculating a proof parameter using a proof-making algorithm of the verifiable pseudo-random function based on a private key possessed by the in-domain master node, proof=VRF_MakeProof(SK,seed),
where proof represents the proof parameter, and VRF_MakeProof represents the proof-making algorithm of the verifiable pseudo-random function.

6. The method of claim 5, wherein the verifying terminal verifies an overwriting result based on a verifiable pseudo-random function through:
based on the proof-making algorithm of the verifiable pseudo-random function, calculating the proof parameter so as to obtain a result information;
determining whether the post-deletion state and the result information are equal; and
if the two are equal, proceeding with verification.

7. The method of claim 6, wherein the verifying terminal verifies the overwriting result based on the verifiable pseudo-random function further through:
performing verification based on a public key possessed by the verifying terminal, the random seed, and the proof parameter, and
if a result of the verification is False, determining that verification fails and random overwriting of deletion target fails; or
if the result of the verification is True, determining that verification succeeds.

8. A server for overwriting-based deletion of information and verification of deletion, wherein the server is for:
receiving a deletion request and random seed;
performing fine-grained overwriting on the information by means of random overwriting;
in response to an extraction request for extracting a post-deletion state, making a master node in a source domain of the information broadcast the extraction request to at least one slave node; and
sending the post-deletion state fed back by the slave node and a related state-verification parameter to a verifying terminal, so that the verifying terminal verifies an overwriting result based on a verifiable pseudo-random function.

9. The server of claim 8, wherein the server is configured to determine at least one random overwriting policy based on a deletion requirement of the verifying terminal.

10. The server of claim 9, wherein the random overwriting policy is selected at least from:
a single-time overwriting policy, which is about making rule-based changes to the random seed corresponding to a counter mode, and overwriting a target storage area in the slave node in a chunkwise manner, wherein the target storage area stores information to be deleted; and
a repetitive overwriting policy, which is about overwriting the target storage area by alternately using at least two different overwriting means, and the third overwriting method is used to perform the last overwriting operation of the target storage area.

11. The server of claim 10, wherein the overwriting means at least include one of:
using the random number to overwrite the target storage area;
using the random number bitwise negation result to overwrite the target storage area; and
making the rule-based changes to the random seed corresponding to the counter mode, and overwriting chunks of the target storage area, respectively.

12. The server of claim 11, wherein the verification parameter related to the post-deletion state is calculated at least through:
calculating a proof parameter using a proof-making algorithm of the verifiable pseudo-random function based on a private key possessed by the in-domain master node, proof=VRF_MakeProof(SK,seed),
where proof represents the proof parameter, and VRF_MakeProof represents the proof-making algorithm of the verifiable pseudo-random function.

13. The server of claim 12, wherein the verifying terminal verifies an overwriting result based on a verifiable pseudo-random function through:
based on the proof-making algorithm of the verifiable pseudo-random function, calculating the proof parameter so as to obtain a result information;
determining whether the post-deletion state and the result information are equal; and
if the two are equal, proceeding with verification.

14. A system for overwriting-based deletion of information and verification of deletion, wherein the system comprises at least one verifying terminal and a server, wherein the verifying terminal is for:
sending a deletion request and/or random seed to the server; and
receiving a post-deletion state and its related verification parameter sent by the server and verifying overwriting result based on a verifiable pseudo-random function; and
the server is for:
receiving a deletion request and random seed;
performing fine-grained overwriting on the information by means of random overwriting;
in response to an extraction request for extracting the post-deletion state, making a master node in a source domain of the information broadcast the extraction request to at least one slave node; and
sending the post-deletion state fed back by the slave node and a related state-verification parameter to a verifying terminal, so that the verifying terminal verifies an overwriting result based on a verifiable pseudo-random function.

15. The system of claim 14, wherein the server performs fine-grained overwriting on the information by means of random overwriting at least through:
determining at least one random overwriting policy based on a deletion requirement of the verifying terminal;
wherein the random overwriting policy at least includes:
a single-time overwriting policy, which is about making rule-based changes to the random seed corresponding to a counter mode, and overwriting a target storage area in the slave node in a chunkwise manner, wherein the target storage area stores information to be deleted; and
a repetitive overwriting policy, which is about overwriting the target storage area by alternately using at least two different overwriting means, and the third overwriting method is used to perform the last overwriting operation of the target storage area.

16. The system of claim 15, wherein the step of performing fine-grained overwriting on the information by means of random overwriting at least comprises:
determining at least one random overwriting policy based on a deletion requirement of the verifying terminal.

17. The system of claim 16, wherein the random overwriting policy is selected at least from:
a single-time overwriting policy, which is about making rule-based changes to the random seed corresponding to a counter mode, and overwriting a target storage area in the slave node in a chunkwise manner, wherein the target storage area stores information to be deleted; and
a repetitive overwriting policy, which is about overwriting the target storage area by alternately using at least two different overwriting means, and the third overwriting method is used to perform the last overwriting operation of the target storage area.

18. The system of claim 17, wherein the overwriting means at least include one of:
using the random number to overwrite the target storage area;
using the random number bitwise negation result to overwrite the target storage area; and
making the rule-based changes to the random seed corresponding to the counter mode, and overwriting chunks of the target storage area, respectively.

19. The system of claim 18, wherein the verification parameter related to the post-deletion state is calculated at least through:
calculating a proof parameter using a proof-making algorithm of the verifiable pseudo-random function based on a private key possessed by the in-domain master node, proof=VRF_MakeProof(SK,seed),
where proof represents the proof parameter, and VRF_MakeProof represents the proof-making algorithm of the verifiable pseudo-random function.

20. The system of claim 19, wherein the verifying terminal verifies an overwriting result based on a verifiable pseudo-random function through:
based on the proof-making algorithm of the verifiable pseudo-random function, calculating the proof parameter so as to obtain a result information;
determining whether the post-deletion state and the result information are equal; and
if the two are equal, proceeding with verification.
